(19) United States
(12) Patent Application Publication
(10) Pub. No.: US 2008/0276483 A1
(43) Pub. Date: Nov. 13, 2008

(54) DRYING ROLL

(76) Inventors: Herbert Boden, St. Polten (AT); Rainer Kloibhofer, Neumarkt (AT); Thomas Gruber-Nadlinger, Langenrohr (AT); Gunter Seitlhuber, Herzongenburg (AT); Robert Bunzl, Mistelbach (AT)

Correspondence Address: Todd T. Taylor;Taylor & Aust, P.C., 142 S. Main Street, P.O. Box 560, Avilla, IN, 46710, US

(21) Appl. No.: 11/931,221

(22) Filed: Oct. 31, 2007

Related U.S. Application Data
(63) Continuation of application No. PCT/EP2006/061868, filed on Apr. 27, 2006.

(30) Foreign Application Priority Data
May 13, 2005 (DE) 20 2005 020 588.5
May 13, 2005 (DE) 20 2005 020 589.3
Apr. 5, 2006 (DE) 10 2006 015 796.6

(51) Int. Cl. F26B 3/00

(52) U.S. Cl. 34/445

(57) ABSTRACT

The invention relates to a drying roll for drying a fibrous material web, in particular a paper, cardboard or tissue web in a machine for producing and/or finishing said fibrous material web. The roll can be heated on the interior by a gaseous heat transfer medium and the internal surface of its jacket is provided with elevated sections that extend at least radially inwards, the height of said elevations being greater than the average radial thickness of the condensate layer that forms on the internal surface of the cylinder jacket during operation. The roll is equipped with elements that drain condensate from the condensate chamber that incorporates the areas lying between the elevations. The condensate chamber or at least one condensate sub-section is in hydraulic contact with at least one front-end region of the cylinder.

### CROSS REFERENCE TO RELATED APPLICATIONS

This is a continuation of PCT application No. PCT/EP2006/061868, entitled “DRYING ROLL”, filed Apr. 27, 2006, which is incorporated herein by reference.

### BACKGROUND OF THE INVENTION

1. Field of the Invention

The invention relates to a drying roll for drying a fibrous material web, in particular a paper, cardboard or tissue web, in a machine for producing and/or finishing said fibrous material web, which roll can be heated from the inside by a gaseous heat transfer medium, and the internal surface of its jacket is provided with elevations that extend at least essentially radially inwards, the radial height of said elevations being greater than the average radial thickness of the condensate layer that forms on the internal surface of the cylinder jacket during operation, in conjunction with which a way is provided for draining condensate from the condensate chamber that incorporates the areas lying between the elevations.

2. Description of the Related Art

In drying rolls of this kind, steam is used predominantly as the heating medium. The removal of heat during the drying of the fibrous material web results in a phase transition and thus to the formation of condensate. At customary machine operating speeds, a condensate layer forms on the inside of the cylinder jacket as the result of centrifugal force. This condensate layer has high thermally insulating properties and as such impairs the transfer of heat from the steam to the fibrous material web.

Consequently, drying rolls with radially oriented grooves have already been proposed, of which the ribs project to a small extent from the condensate. A drying roll of this kind is previously disclosed, for example, in EP 0 851 059 A1. In this previously disclosed drying roll, the item in question can be, in particular, a Yankee roll with condensate grooves oriented in the circumferential direction. The condensate is sucked directly from the grooves via siphons. The most stable construction possible is believed to be achieved by a special configuration of the ribs.

A drying roll previously disclosed in DE 10 2004017 811 A1 possesses a thin-shelled jacket with reinforcing elements and two jacket layers, in order to avoid deformation in spite of the thin wall thickness.

What is needed in the art is to make available an improved drying roll of the kind mentioned by way of introduction, in which an improved heat transfer and a higher heat flux density are provided, while retaining a simple construction, and which is also capable in particular of being manufactured in an economical manner.

### SUMMARY OF THE INVENTION

The present invention provides that the condensate chamber or at least one condensate sub-section is in hydraulic contact with at least one front-end region of the cylinder.

In this case, the drying roll can be heated in particular by steam, in conjunction with which the steam chamber can extend, at least in essential respects, over the entire internal space or can consist only of individual chambers, as described in DE 10 2004 017 811 A1, for example.

At least one condensate outflow arrangement can be provided in at least one front-end region of the cylinder.

The condensate outflow arrangement can include a condensate collection channel, which is advantageously oriented in the circumferential direction.

According to an appropriate, practical embodiment of the cylinder according to the invention, at least one siphon is allocated to the condensate collection channel. Outflow of the condensate in this case can be effected, for example, via at least one siphon on each side on which the arriving flow is received.

A further advantageous embodiment is characterized in that a section having a larger internal diameter by comparison with the cylinder jacket adjoins the axial outflow of the condensate axially at least at one end of the cylinder jacket, and in that a corresponding seal is provided on the cylinder jacket. The condensate in this case is spun onto the larger diameter, or else it flows out when at a standstill.

According to a further aspect of the invention, the present invention provides that at least one condensate outflow element for the outflow of the condensate is present in the condensate chamber or in at least one condensate sub-section. A measure of this kind is possible as an alternative to or in addition to the measures concerning the first aspect of the invention.

A condensate outflow element of this kind can include a siphon.

In certain cases, it may also be of advantage for the condensate outflow element to include a small tubular siphon, that is to say a siphon in the form of a small tube. A small tubular siphon of this kind is previously disclosed in EP 0 851 059 A1.

The present invention also provides that the elevations are provided, at least partially, in the form of ribs, between which grooves are formed, and in that the proportion of the width of the groove at the radially external base of the groove to the pitch of the ribs is greater than around 0.1 and smaller than around 0.95. This measure, which also concerns a further aspect of the invention, can in turn be provided as an alternative to or in combination with the measures for at least one of the aspects of the invention described above.

The proportion of the width of the groove to the pitch of the ribs is preferably greater than around 0.3 and smaller than around 0.7.

In particular in the case of a cylinder made of steel, the proportion of the width of the groove to the pitch of the ribs is preferably in the order of around 0.5 to around 0.6.

The elevations can also be provided, at least partially, in particular in the form of bolts. In this case, the proportion of the surface of the cylinder jacket in contact with the condensate to its inner total surface is advantageously greater than around 0.1 and smaller than around 0.95.

According to a preferred practical embodiment, the proportion of the surface of the cylinder jacket in contact with the condensate to its inner total surface is advantageously greater than around 0.3 and smaller than around 0.7. In particular in the case of a cylinder made of steel, this proportion is preferably in the order of around 0.5 to around 0.6.

The condensate outflow device advantageously includes at least one siphon-like element.

It is also particularly advantageous if the elevations, at least partially, possess a cross-sectional form such that the angle formed between the two flanks of a particular elevation is ≧0° and <140°.

The point of intersection at which the tangents of the slope are applied to both flanks or flank sections advantageously lies radially between the elevation in each case and the center of the cylinder.

It is also particularly advantageous if the elevations, at least partially, possess an at least essentially rectangular cross-sectional form. A trapezoidal, parabolic or triangular cross-sectional form in particular is also possible.

According to an appropriate, practical embodiment, the elevations are, at least partially, continuous. Embodiments in particular in which the elevations are interrupted, at least partially, are also possible, however.

The elevations are nevertheless also fundamentally capable of possessing any other cross-sectional form. Circular arcs or even evolvents or rectangles, for example, are thus possible. Generally, however, they will preferably possess an on the whole essentially rectangular or trapezoidal cross-sectional form, and any desired curved forms can be provided for the rounding and transition.

One advantageous, practical embodiment of the cylinder according to the invention is characterized in that the elevations include, at least partially, individual sub-sections, for example radial bolt-like sub-sections, radial rod-like sub-sections and the like. The sub-sections in question can, for example, support the walls in relation to one another and/or also profiles arranged in the longitudinal direction, for example.

The elevations in each case advantageously possess, at least partially, a radial height>2 mm. In this case, their radial height can be in particular >3 mm, appropriately >5 mm and preferably >10 mm.

The optimal radial height of the elevations is dependent on their width, that is to say, for example, the width of the rib, and the radial thickness of the condensate layer in the depression or groove. In this case, the radial height of the section of a particular elevation projecting inwards from the condensate layer is preferably greater than or the same as half of the width of the elevation.

The average radial thickness of the condensate layer is around 3 mm, for example. In this case, the average radial thickness of the condensate layer in question is the average thickness obtained over the total inner surface of the cylinder that is supplied with condensate.

The width of a particular elevation is appropriately around 6 mm.

The radial height of a particular elevation is preferably >6 mm, in particular in the case of such an average radial thickness of the condensate layer of around 3 mm and such a width of a particular elevation of around 6 mm.

For a practical application, the radial height of the elevations for all condensate layer thicknesses encountered in operation should ensure the highest possible heat flux density. For this purpose, according to a preferred practical embodiment of the drying roll according to the invention, the radial height of a particular elevation is greater than or the same as half of the width of the elevation measured at the radially external foot of the elevation, plus a value of around 1 mm.

This radial height of a particular elevation is preferably greater than or the same as half of the width of the elevation measured at the radially external foot of the elevation, plus a value of around 3 mm.

The radial height of a particular elevation is preferably at least 6 mm, in particular in the case of an average radial thickness of the condensation layer of around 3 mm, and a width of the elevation of around 6 mm.

In particular in the case of a one-piece construction of the cylinder jacket provided with the elevations, it is advantageous if the radial height of a particular elevation is <18 mm. Economical manufacture is possible as a result, for example by cutting machining of the elevations, such as by milling, while at the same time retaining good heat flux density.

A distinct improvement is also possible due to the improved heat conduction together with correspondingly good conductivity of the material in the case of a two-piece construction at elevation heights of as little as <18 mm, that is to say having a height as in the case of a steel embodiment, for example. A greater elevation height may be selected, of course, in order to introduce even more heat through the even larger surface. It is fundamentally also able to function, however, with the same height as in the case of a steel embodiment. Elevation heights of >18 mm can be advantageous in particular in the case in which the elevations or ribs consist of a material having a higher thermal conductivity, that is to say, for example, copper, aluminum, alloys, etc.

An advantageous height of the elevation is <30 mm, in particular in the case of a one-piece cast embodiment, taking into account a larger pitch and a larger average rib width that are necessary for the manufacture of the casting.

The pitch of the elevations or ribs is advantageously <100 mm, in conjunction with which it can be appropriately <50 mm, in particular <30 mm and preferably <15 mm.

If the elevations are present, at least partially, in the form of ribs, between which grooves are formed, the proportion of the average groove width to the pitch of the ribs is greater than around 0.1 and smaller than around 0.95. In this case, the expression average groove width is intended to denote the average width produced over the radial extent of the groove.

In one appropriate, practical embodiment, this proportion of the average groove width to the pitch of the ribs is greater than around 0.3 and smaller than around 0.7.

In particular in the case of a cylinder made of steel, this proportion of the average groove width to the pitch of the ribs is appropriately in the order of around 0.5 to around 0.7, and preferably in the order of 0.66.

According to an advantageous, practical embodiment of the drying roll according to the invention, the transition between a particular elevation and the radially external base of an adjoining depression is rounded in each case. If the elevations are present, at least partially, in the form of ribs, between which grooves are formed, the transition between a particular rib and the base of the groove is advantageously also rounded. Given that the area around the transition concerned consequently does not exhibit any sharp edges, a notch effect is prevented, which would otherwise arise, since the cylinder in question is a pressure vessel.

The transition in question advantageously possesses a radius of >1 mm, and preferably >2 mm.

If the elevations are present, at least partially, in the form of ribs, between which grooves are formed, the ribs and the grooves can also be advantageously oriented axially, at least partially, or also in the circumferential direction.

According to an appropriate, practical embodiment, all the ribs and grooves are oriented in an axial direction. As an alternative, it may also be advantageous in certain cases if all the ribs and grooves are oriented in the circumferential direction.

If the ribs and the grooves are oriented, at least partially, in the circumferential direction, the grooves according to a further appropriate embodiment are attached to one another, at least partially, via channels.

In the event that the elevations are present, at least partially, in the form of ribs, between which grooves are formed, at least one condensate outflow element is allocated to each particular groove according to a practical embodiment.

It is also particularly advantageous for at least one siphon to be allocated to each of the particular grooves in question.

If the elevations are present, at least partially, in the form of ribs, between which grooves are formed, the ribs and the grooves can, at least partially, according to a further advantageous embodiment, also be oriented in the form of a spiral, in the form of a coil or in the form of a screw thread.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 depicts a schematic representation in cross section of an illustrative embodiment of a drying roll, the jacket of which is provided on the inside with axially oriented ribs;

FIG. 2 depicts a detail of the jacket of the drying roll according to FIG. 1, in which the ribs possess a trapezoidal cross-sectional form;

FIG. 3 depicts a representation that is comparable with that in FIG. 2, in which the ribs possess a rectangular cross-sectional form;

FIG. 4 depicts a representation that is comparable with that in FIG. 2, in which the ribs similarly possess a rectangular cross-sectional form, although they exhibit a smaller width by comparison with the grooves;

FIG. 5 depicts a representation that is comparable with that in FIG. 2, in which the ribs possess a parabolic cross-sectional form;

FIG. 6 depicts a representation that is comparable with that in FIG. 2, in which the ribs possess an essentially round cross-sectional form;

FIG. 7 depicts a representation that is comparable with that in FIG. 2, in which the ribs possess a triangular cross-sectional form;

FIG. 8 depicts a representation that is comparable with that in FIG. 2, however in which the cylinder jacket provided with the ribs possesses a multi-piece construction;

FIG. 9 depicts a schematic representation in cross section of a further embodiment of the drying roll, the jacket of which is provided on the inside with ribs oriented in the circumferential direction;

FIG. 10 depicts a detail of the jacket of the drying roll according to FIG. 9, in which the ribs possess a trapezoidal cross-sectional form;

FIG. 11 depicts a representation that is comparable with that in FIG. 10, in which the ribs possess a rectangular cross-sectional form;

FIG. 12 depicts a representation that is comparable with that in FIG. 10, in which the ribs similarly possess a rectangular cross-sectional form, although they exhibit a smaller width by comparison with the grooves;

FIG. 13 depicts a representation that is comparable with that in FIG. 10, in which the ribs possess a parabolic cross-sectional form;

FIG. 14 depicts a representation that is comparable with that in FIG. 10, in which the ribs possess an essentially round cross-sectional form;

FIG. 15 depicts a representation that is comparable with that in FIG. 10, in which the ribs possess a triangular cross-sectional form;

FIG. 16 depicts a representation that is comparable with that in FIG. 10, however in which the cylinder jacket provided with the ribs possesses a multi-piece construction;

FIG. 17 depicts a schematic representation in longitudinal section of a part of a further embodiment of a drying roll having a condensate collection channel, provided in a front-end region of the cylinder, in the form of a condensate groove executed on the inside of the jacket;

FIG. 18 depicts a schematic representation in cross section of the front-end region of the cylinder according to FIG. 17, sectioned along the line I-I in FIG. 17;

FIG. 19 depicts a schematic representation in longitudinal section of a part of a further embodiment of a drying roll having an axially oriented condensate collection tube, into which a plurality of small tubular siphons discharge, which in each case project with their other end into a groove that is present on the inside of the jacket;

FIG. 20 depicts a schematic representation in cross section of the drying roll according to FIG. 19, sectioned along the line I-I in FIG. 19;

FIG. 21 depicts a representation that is comparable with that in FIG. 2 and FIG. 10, for the purpose of illustrating an example of a practical rib geometry;

FIG. 22 depicts a representation that is comparable with that in FIG. 21 of an example of another rib geometry; and

FIG. 23 depicts a representation that is comparable with that in FIG. 21 of a further illustrative embodiment.

Corresponding reference characters indicate corresponding parts throughout the several views. The exemplifications set out herein illustrate embodiments of the invention, and such exemplifications are not to be construed as limiting the scope of the invention in any manner.

### DETAILED DESCRIPTION OF THE INVENTION

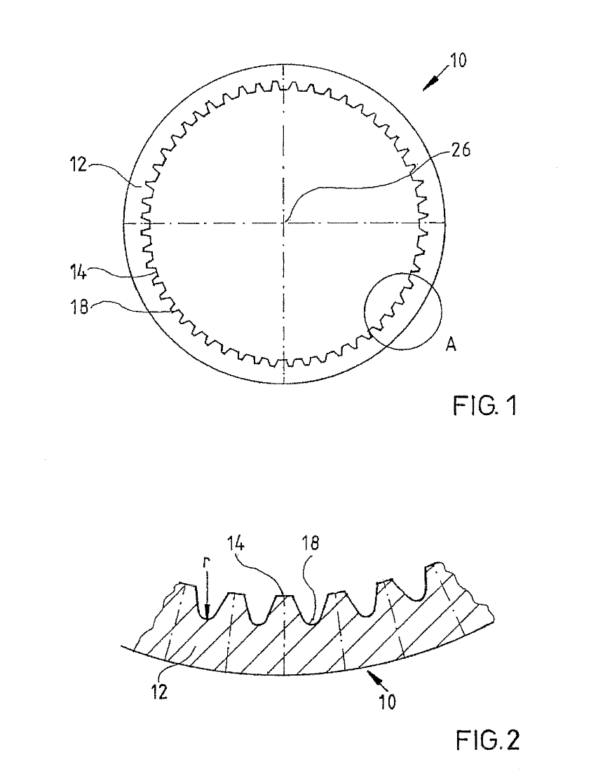

Referring now to the drawings, and more particularly to FIG. 1, there is shown a schematic representation in cross section of an illustrative embodiment of a drying roll 10 for drying a fibrous material web in a machine for producing and/or finishing said fibrous material web. The fibrous material web in this case can be in particular a paper, cardboard or tissue web.

The drying cylinder 10 can be heated from the inside by a gaseous heat transfer medium, in particular such as steam.

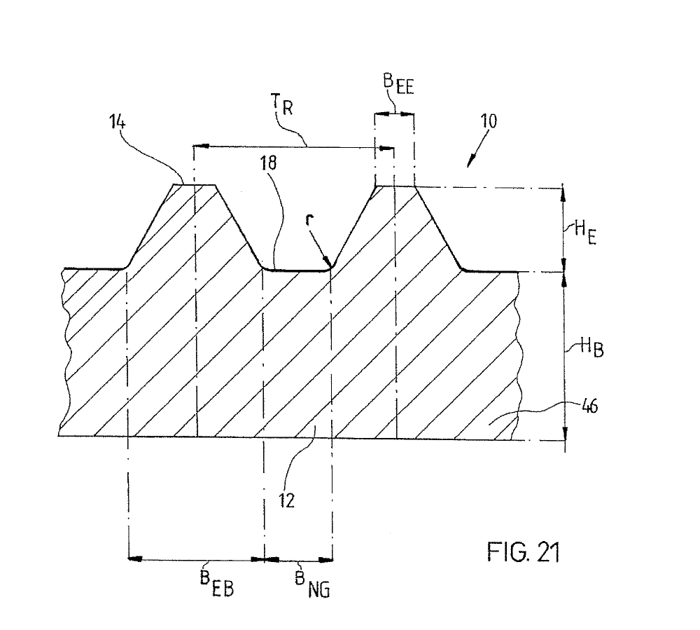

The cylinder jacket 12 is provided on its internal surface with elevated sections 14 that extend at least essentially radially inwards. The radial height HE of these elevations 14 is greater than the average radial thickness D_{K} of the condensate layer 16 that forms on the internal surface of the cylinder jacket 12 during operation (see also FIGS. 21 to 23 in particular).

The expression average radial thickness D_{K} of the condensate layer 16 is intended to denote the average value of the various thicknesses of the condensate layer that are produced during operation over the entire internal surface of the cylinder jacket 12.

A way, which is described in greater detail below, is provided for the purpose of draining condensate from the condensate chamber that incorporates the areas lying between the elevations 14. The cylinder jacket 12 can define, in whole or in part, the condensate chamber. The condensate chamber can be formed by a single chamber or can be divided into condensate sub-chambers.

The condensate is led away from this condensate chamber or these condensate sub-sections via condensate outflow elements.

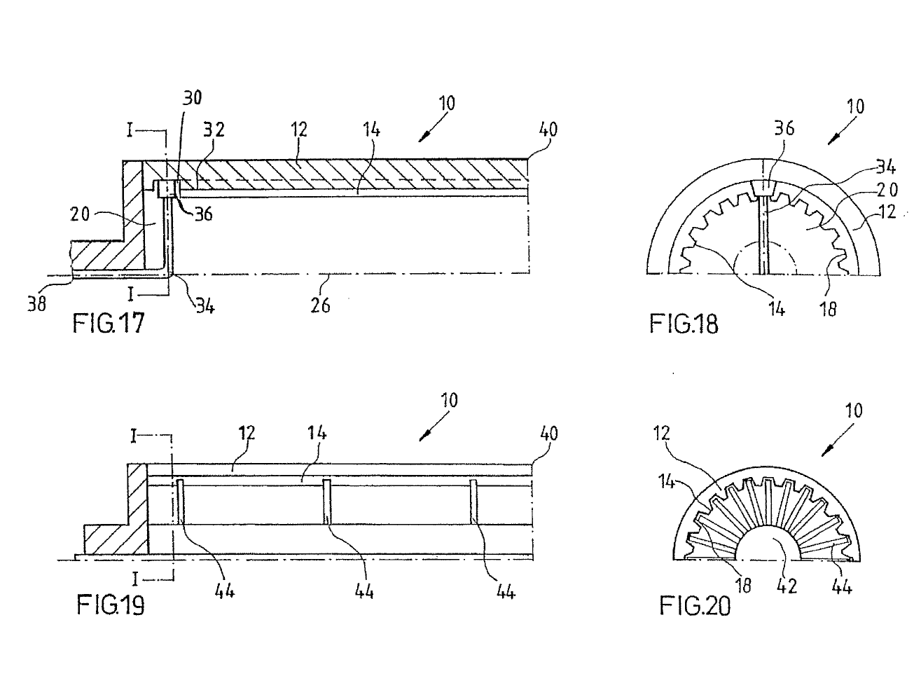

The condensate chamber or at least one condensate sub-section is advantageously in hydraulic contact in this case with at least one front-end region of the cylinder (see, for example, FIGS. 17 and 18).

In the present embodiment, the elevations 14 are formed by axially oriented ribs. The interjacent grooves are also oriented accordingly in the axial direction.

FIG. 2 depicts a detail A of the jacket 12 of the drying roll 10 according to FIG. 1. As can be appreciated from this FIG. 2, the rib-like elevations 14 in the present case possess a trapezoidal cross-sectional form, for example. The transition between the base of the grooves 18 and the rib-like elevations 14 is rounded and is defined here by a radius r.

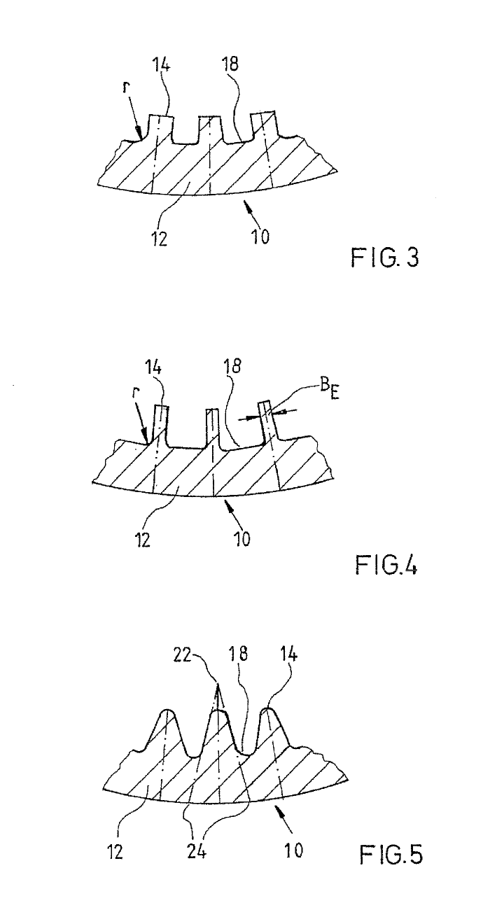

FIG. 3 depicts a representation that is comparable with that in FIG. 2, in which the rib-like elevations 14 possess a rectangular cross-sectional form, however. The transitions between the grooves 18 and the rib-like elevations 14 are similarly rounded.

FIG. 4 depicts a further representation that is comparable with that in FIG. 2. In this case, too, the rib-like elevations 14 similarly possess a rectangular cross-sectional form. They exhibit a smaller width B in this case by comparison with the grooves 18.

FIG. 5 depicts a representation that is comparable with that in FIG. 2, in which the rib-like elevations 14 possess a parabolic cross-sectional form.

As can be appreciated from FIG. 5, the point of intersection 22 at which the tangents of the slope 24 are applied to both flanks lies radially between the rib-like elevation 14 in each case and the center 26 of the cylinder (see also FIG. 1).

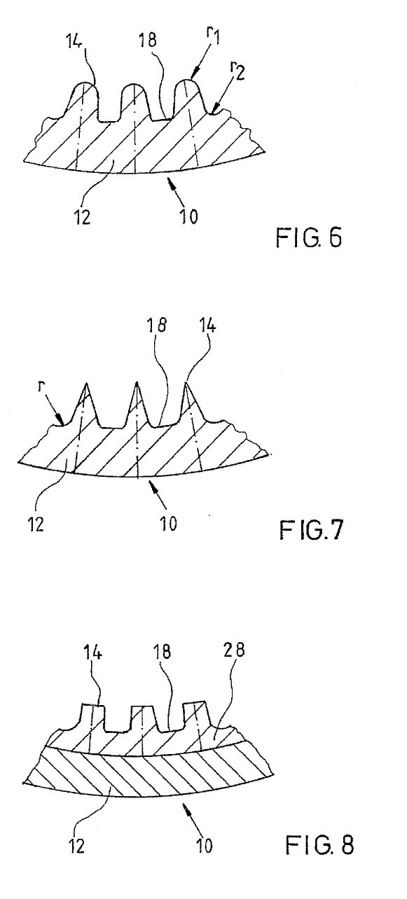

FIG. 6 depicts a further representation that is comparable with that in FIG. 2. In the present case, however, the rib-like elevations 14 possess an essentially round cross-sectional form.

The transitions between the grooves 18 and the rib-like elevations 14 can also be similarly rounded in this case. In the present embodiment, the roundings at the free end of the rib-like elevations and the rounded transitions are defined by various radii r₁ and r₂.

FIG. 7 depicts a representation that is comparable with that in FIG. 2, in which the rib-like elevations 14 possess a triangular cross-sectional form. The transitions between the grooves 18 and the rib-like elevations 14 can be similarly rounded, and they are defined by the radius r in this case.

In the various embodiments in FIGS. 1 to 7, the cylinder jacket 12 provided with the elevations 14 possesses a one-piece construction.

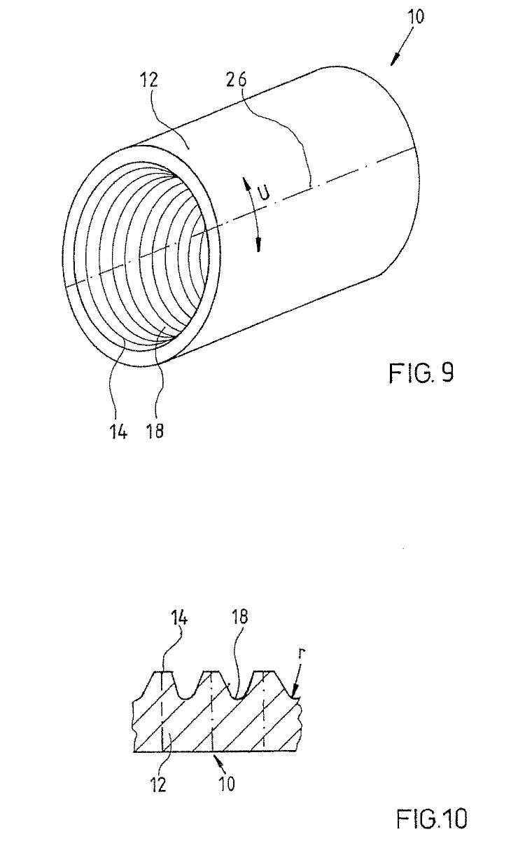

FIG. 8, on the other hand, depicts, in a representation that is comparable with that in FIG. 2, a detail of a cylinder jacket 12 with a multi-piece construction. In this case, the rib-like elevations 14 are executed separately from the outer jacket shell. As can be appreciated from FIG. 8, the rib-like elevations 14 are present on an inner shell 28 that is executed separately from the outer jacket shell.

The rib-like elevations 14 in turn possess, for example, a rectangular cross section.

FIG. 9 depicts a schematic representation in cross section of a further embodiment of the drying roll 10, the jacket 12 of which is provided on the inside with rib-like elevations 14. In the case of the present illustrative embodiment, however, these rib-like elevations 14 are oriented in the circumferential direction U. The interjacent grooves 18 also possess a corresponding orientation in the circumferential direction U.

FIG. 10 depicts a detail of the jacket 12 of the drying roll 10 according to FIG. 10, which corresponds here to an axial section.

In the present illustrative embodiment, the rib-like elevations 14 possess a trapezoidal cross-sectional form, for example. The transitions between the grooves 18 and the rib-like elevations 14 are similarly rounded, and they are defined here, for example, by the radius r.

FIG. 11 depicts a representation that is comparable with that in FIG. 10, in which the rib-like elevations 14 possess a rectangular cross-sectional form. The transitions between the grooves 18 and the rib-like elevations 14 are similarly rounded, in conjunction with which the roundings in each case are similarly defined by a radius r.

FIG. 12 depicts a further representation that is comparable with that in FIG. 10, in which the rib-like elevations 14 similarly possess a rectangular cross-sectional form. In the present case, however, the elevations 14 exhibit a smaller width by comparison with the grooves 18.

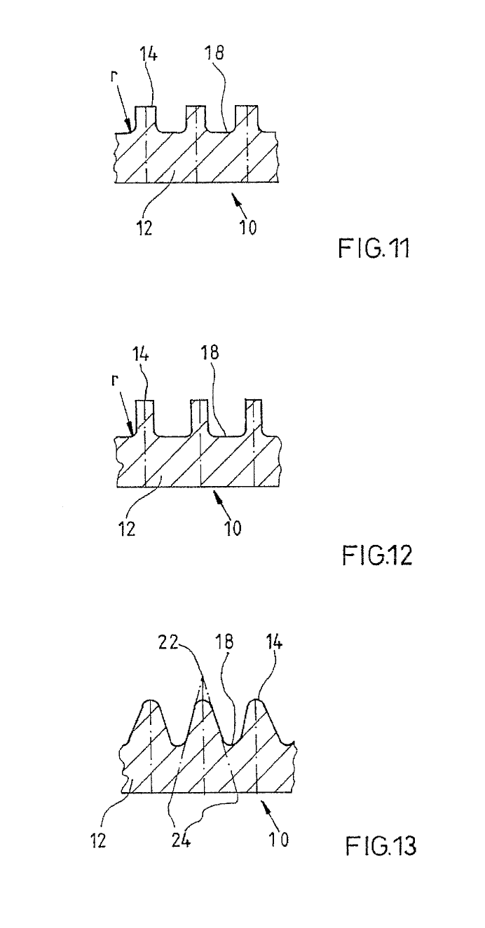

FIG. 13 depicts a representation that is comparable with that in FIG. 10, in which the rib-like elevations 14 possess a parabolic cross-sectional form, however.

The point of intersection at which the tangents of the slope 24 are applied to both flanks similarly lies radially between the elevation 14 in each case and the center 26 of the cylinder (see also FIG. 9).

Depicted in FIG. 14 is a further representation that is comparable with that in FIG. 10. In the present case, the rib-like elevations 14 similarly possess an essentially round cross-sectional form. The transitions between the grooves 18 and the rib-like elevations 14 are similarly rounded, and they are defined here, for example, by a radius r in each case.

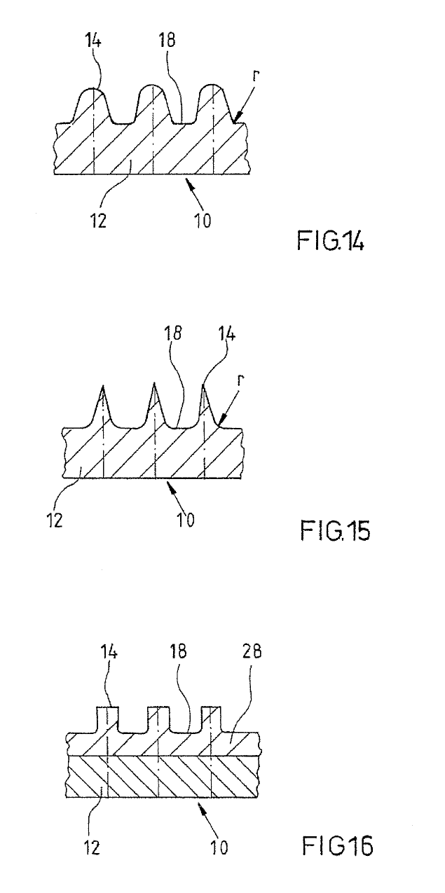

FIG. 15 depicts a further representation that is comparable with that in FIG. 10, in which the rib-like elevations 14 possess a triangular cross-sectional form, however. The transitions between the grooves 18 and the rib-like elevations 14 are similarly rounded, in conjunction with which the roundings in each case are similarly defined by a radius r, for example.

In the embodiments reproduced by way of example in FIGS. 9 to 15 with rib-like elevations 14 and grooves 18 oriented in the circumferential direction (see FIG. 9), the cylinder jacket 12 provided with the elevations 14 possesses a one-piece construction.

FIG. 16, on the other hand, depicts a representation that is comparable with that in FIG. 10 of a corresponding detail of a cylinder jacket 12 with a multi-piece construction. The rib-like elevations 14 and the interjacent grooves 18 are similarly oriented in the circumferential direction U in this case, too. However, the elevations 14 in this case are present on an inner shell 28 of the cylinder jacket 12 that is executed separately from the outer jacket shell. The rib-like elevations 14 in this case similarly possess a rectangular cross section, for example.

FIG. 17 depicts a schematic representation in longitudinal section of a part of a further embodiment of a drying roll 10 having a condensate collection channel 30, provided in a front-end region 20 of the cylinder, in the form of a condensate groove executed on the inside of the jacket. As can be appreciated from FIG. 17, the base of the groove lies deeper, that is to say radially outside the base 32 of the various grooves 18 (see also FIG. 1, for example).

The rib-like elevations 14 are similarly oriented axially, for example, in this case. The condensate collection channel or groove 30 provided on the inside of the jacket in at least one front-end region 20 of the cylinder is oriented in the circumferential direction.

As can be appreciated from FIG. 17, the grooves 18 (see also FIG. 1, for example) that are formed between the rib-like elevations 14 discharge into the condensate collection channel 30. From the latter, the condensate is drained via an upright or rotating siphon 34, for example, having one or a plurality of siphon heads 36. The condensate 38 in this case is discharged laterally from the drying roll 10.

As previously mentioned, a condensate outflow element of this kind, for example including one siphon or a plurality of siphons, can only be provided in one end region 20 of the cylinder or also in both end regions of the cylinder. In the case of a rotating siphon in particular, a plurality of siphons can be provided appropriately in a condensate channel on the end of the cylinder.

Represented in FIG. 17 is only an upper, left-hand detail of the drying roll 10, which extends from the left-hand end region 20 of the cylinder as far as the central plane 40.

FIG. 18 depicts a schematic representation in cross section of the front-end region 20 of the drying roll according to FIG. 17, sectioned along the line I-I in FIG. 17. As can be appreciated from this FIG. 18, the rib-like elevations 14 similarly possess a trapezoidal cross section, for example.

FIG. 19 depicts a schematic representation in longitudinal section of a part of a further embodiment of a drying roll 10 having an axially oriented condensate collection tube 42, into which a plurality of small tubular siphons 44 discharge, which siphons in each case project with their other end into a groove 18 (see also FIG. 20) that is present on the inside of the jacket.

Axially oriented, continuous, rib-like elevations 14 are provided in the present case. The interjacent grooves 18 (see FIG. 20) are oriented correspondingly in the axial direction.

One or also a plurality of small tubular siphons 44 can project into a particular groove 18 for the purpose of draining condensate and discharging it into the condensate collection tube 42. At least one small tubular siphon 44 can be allocated to a particular groove 18 in each case.

FIG. 20 depicts a schematic representation in cross section of the drying roll 10 according to FIG. 19, sectioned along the line I-I in FIG. 19. As can be appreciated from FIG. 20, a radially oriented small tubular siphon 44 discharging into the axial condensate collection tube 42 is allocated to each particular groove 18 in the present case. These small tubular siphons 44 can also be arranged so that they are distributed in the axial direction (see FIG. 19).

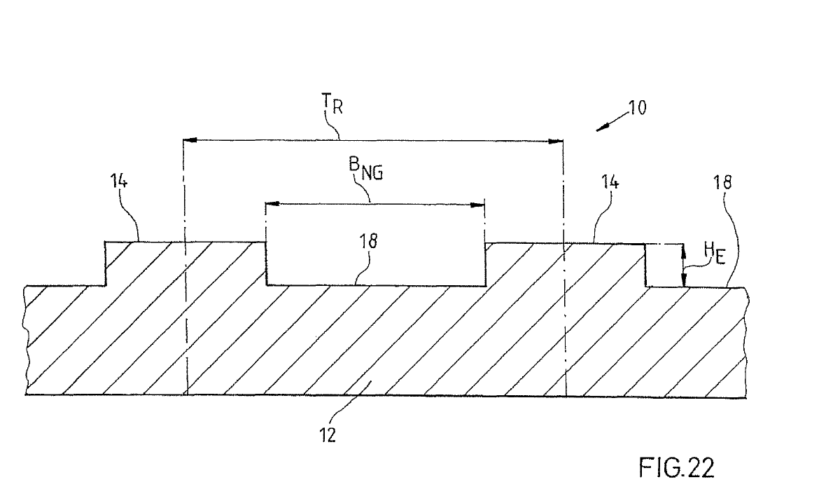

The elevations 14 can be present, at least partially, in the form of ribs, between which grooves 18 are formed. The proportion of groove width B_{NG} at the radially external base of the groove to the pitch of the ribs T_{R} is now advantageously greater than around 0.1 and smaller than around 0.95, and preferably greater than around 0.3 and smaller than around 0.7 (see FIG. 21, for example). In the case of a drying roll 10 made of steel, this proportion of the groove width B_{NG} to the pitch of the ribs T_{R} is preferably in the order of 0.5 (see FIG. 22, for example).

FIG. 21 depicts a representation that is comparable with that in FIG. 2 and FIG. 10, for the purpose of illustrating an example of a practical rib geometry. In this case, as already mentioned above, the proportion of the groove width B_{NG} to the pitch of the ribs T_{R} can advantageously be greater than around 0.1 and smaller than around 0.95, and preferably greater than around 0.3 and smaller than around 0.7.

In the present embodiment, a particular rib-like elevation 14 having an at least essentially trapezoidal cross section possesses a width B_{EB} of around 6 mm at the base, for example, and a width B_{EE} of around 2 mm at the free end, for example. The width of the groove B_{NG} at the radially external base of the groove is around 6 mm, for example. The transitions between the grooves 18 and the rib-like elevations 14 can similarly be rounded, for example. In the present case, the roundings are defined, for example, by a radius r=2.5 mm. Other radii are fundamentally possible, however. The radial height H_{E} of the rib-like elevations 14 lies in a range from around 5 mm to around 10 mm, for example. The pitch T_{R} of the rib-like elevations 14 is 12 mm, for example. The radially external basic section 46 of the cylinder jacket 12, which is adjoined radially inwards by the rib-like elevations 14, possesses a radial height H_{B} in a range from around 20 mm to around 25 mm, for example.

FIG. 22 depicts a representation that is comparable with that in FIG. 21 of an example of another rib geometry. In this particular case, the rib-like elevations 14 possess a rectangular cross-sectional form, for example. The width of the groove B_{NG} at the radially external base of the groove is around 50 mm, for example, in this case. The radial height H_{E} of a particular rib-like elevation 14 is the order of around 25 mm, for example. The pitch T_{R} of the rib-like elevations 14 is around 100 mm, for example.

In the present case, the proportion of the groove width B_{NG} to the pitch of the ribs T_{R} is around 0.5, for example, which is advantageous in particular for a drying roll 10 made of steel.

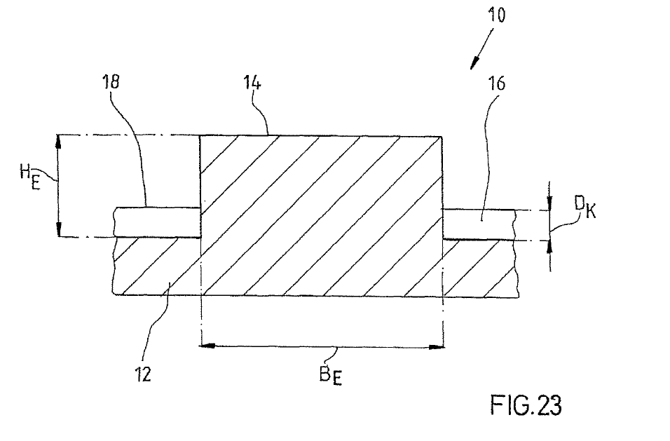

FIG. 23 depicts a representation that is comparable with that in FIG. 21 of a further illustrative embodiment, in which the rib-like elevations 14 similarly possess a rectangular cross-sectional form, for example.

The width of a particular elevation 14 is indicated with “B_{E}”, and the radial height of a particular elevation 14 is similarly indicated with “H_{E}”. The radial thickness of the condensate layer that is formed on the inside of the cylinder jacket 12 is indicated with “D_{K}”.

At the same time, the following equation should preferably be applied for the indicated quantities, and in particular where the ribs are made of steel:

$${H}_{E} - {D}_{K} = \frac{{B}_{E}}{2}$$

Steel exhibits very poor heat transfer compared with aluminum or copper. Consequently, a large rib height does not make much sense in this case. A certain rib width is required, however, in order to lead through the energy.

In particular, the average thickness of the condensate layer may similarly be taken as the thickness D_{K} of the condensate layer 16.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

### LIST OF REFERENCE DESIGNATIONS

10 drying roll
12 cylinder jacket
14 elevation
16 condensate layer
18 groove
20 end region of the cylinder
22 point of intersection
24 tangent of the slope
26 center of the cylinder
28 inner shell
30 condensate collection channel
32 base of the groove
34 condensate outflow arrangement, condensate outflow element, siphon
36 siphon head
38 condensate
40 central plane
42 condensate collection tube
44 condensate outflow arrangement, condensate outflow element, small tubular siphon
46 basic section
B_{E} width
B_{EB} width of an elevation at the base
B_{EE} width of an elevation at the free end
B_{NG} width of the groove at the base of the groove
D_{K} average thickness of the condensate layer
H_{B} radial height of the outer jacket base
H_{E} radial height of an elevation
T_{R} pitch of the rib-like elevation
U circumferential direction
r radius

What is claimed is:

1. A drying roll for drying a web of fibrous material in a machine for at least one of producing and finishing the web, the drying roll configured for being heated from an inside area of the drying roll by a gaseous heat transfer medium, said drying roll comprising:
a cylinder jacket, a condensate outflow arrangement, and a front-end region, said cylinder jacket defining, at least in part, a condensate chamber, said cylinder jacket including an internal surface with a plurality of elevations that extends at least essentially radially inwards, a radial height of said plurality of elevations configured for being greater than an average radial thickness of a condensate layer that forms on said internal surface of said cylinder jacket during operation, in conjunction with which said condensate outflow arrangement is configured for draining a condensate from said condensate chamber which includes a plurality of areas lying between said plurality of elevations, said condensate chamber being in hydraulic contact with at least one said front-end region of the drying roll.

2. The drying roll as claimed in claim 1, wherein said condensate chamber includes a plurality of condensate sub-sections, at least one of said plurality of condensate sub-sections being in hydraulic contact with at least one said front-end region of the drying roll.

3. The drying roll as claimed in claim 1, wherein at least one said condensate outflow arrangement is in at least one said front-end region of the drying roll.

4. The drying roll as claimed in claim 3, wherein said condensate outflow arrangement includes a condensate collection channel.

5. The drying roll as claimed in claim 4, wherein said condensate collection channel is oriented in a circumferential direction.

6. The drying roll as claimed in claim 4, wherein said condensate outflow arrangement includes at least one siphon which is allocated to said condensate collection channel.

7. The drying roll as claimed in claim 1, further comprising a section having a larger internal diameter than said cylinder jacket which includes an end, said section being configured for adjoining an axial outflow of said condensate at least at one said end of said cylinder jacket, a corresponding seal being provided on said cylinder jacket.

8. The drying roll as claimed in claim 1, wherein said plurality of elevations are a plurality of bolts.

9. The drying roll as claimed in claim 8, wherein a proportion of a surface of said cylinder jacket in contact with said condensate to an inner total surface of said cylinder jacket is greater than around 0.1 and smaller than around 0.95.

10. The drying roll as claimed in claim 9, wherein said proportion of said surface of said cylinder jacket in contact with said condensate to said inner total surface of said cylinder jacket is greater than around 0.3 and smaller than around 0.7.

11. The drying roll as claimed in claim 10, wherein said proportion of said surface of said cylinder jacket in contact with said condensate to said inner total surface of said cylinder jacket is around 0.5 to around 0.6 when said drying roll is made of steel.

12. The drying roll as claimed in claim 1, wherein said plurality of elevations are provided, at least partially, as a plurality of ribs, between which a plurality of grooves are formed, a proportion of an average groove width to a pitch of said plurality of ribs being greater than around 0.1 and smaller than around 0.95.

13. The drying roll as claimed in claim 12, wherein said proportion of said average groove width to said pitch of said plurality of ribs is greater than around 0.3 and smaller than around 0.7.

14. The drying roll as claimed in claim 13, wherein, when said drying roll is made of steel, said proportion of said average groove width to said pitch of said plurality of ribs is around 0.5 to around 0.8.

15. The drying roll as claimed in claim 13, wherein, when said drying roll is made of steel, said proportion of said average groove width to said pitch of said plurality of ribs is around 0.5 to 0.7.

16. The drying roll as claimed in claim 13, wherein, when said drying roll is made of steel, said proportion of said average groove width to said pitch of said plurality of ribs is around 0.66.

17. A drying roll for drying a web of fibrous material in a machine for at least one of producing and finishing the web, the drying roll configured for being heated from an inside area of the drying roll by a gaseous heat transfer medium, said drying roll comprising:
a cylinder jacket, a condensate outflow arrangement, and a front-end region, said cylinder jacket defining, at least in part, a condensate chamber, said cylinder jacket including an internal surface with a plurality of elevations that extends at least essentially radially inwards, a radial height of said plurality of elevations configured for being greater than an average radial thickness of a condensate layer that forms on said internal surface of said cylinder jacket during operation, in conjunction with which said condensate outflow arrangement is configured for draining a condensate from said condensate chamber which includes a plurality of areas lying between said plurality of elevations, said condensate chamber being in hydraulic contact with at least one said front-end region of the drying roll, said condensate outflow arrangement including at least one condensate outflow element configured for accommodating an outflow of said condensate, said at least one condensate outflow element being in said condensate chamber.

18. The drying roll as claimed in claim 17, wherein said condensate chamber includes a plurality of condensate sub-sections, at least one of said plurality of condensate sub-sections being in hydraulic contact with at least one said front-end region of the drying roll, said at least one condensate outflow element being in said at least one of said plurality condensate sub-sections.

19. The drying roll as claimed in claim 17, wherein said condensate outflow element includes a siphon.

20. The drying roll as claimed in claim 19, wherein said siphon includes a small tubular siphon which is in a form of a small tube.

21. A drying roll for drying a web of fibrous material in a machine for at least one of producing and finishing the web, the drying roll configured for being heated from an inside area of the drying roll by a gaseous heat transfer medium, said drying roll comprising:
a cylinder jacket, a condensate outflow arrangement, and a front-end region, said cylinder jacket defining, at least in part, a condensate chamber, said cylinder jacket including an internal surface with a plurality of elevations that extends at least essentially radially inwards, a radial height of said plurality of elevations configured for being greater than an average radial thickness of a condensate layer that forms on said internal surface of said cylinder jacket during operation, in conjunction with which said condensate outflow arrangement is configured for draining a condensate from said condensate chamber which includes a plurality of areas lying between said plurality of elevations, said condensate chamber being in hydraulic contact with at least one said front-end region of the drying roll, said plurality of elevations being, at least partially, a plurality of ribs having a pitch, said internal surface including a plurality of grooves formed between said plurality of ribs, said plurality of grooves each having a radially external base, a proportion of a width of each said groove (B_{NG}) at said radially external base of a respective said groove to said pitch of said plurality of ribs (T_{R}) being greater than around 0.1 and smaller than around 0.95.

22. The drying roll as claimed in claim 21, wherein said condensate chamber includes a plurality of condensate sub-sections, at least one of said plurality of condensate sub-sections being in hydraulic contact with at least one said front-end region of the drying roll.

23. The drying roll as claimed in claim 21, wherein said proportion of said width of each said groove to said pitch of said plurality of ribs is greater than around 0.3 and smaller than around 0.7.

24. The drying roll as claimed in claim 23, wherein said proportion of said width of each said groove to said pitch of said plurality of ribs is around 0.5 to around 0.6 when said drying roll is made of steel.

25. The drying roll as claimed in claim 21, wherein said condensate outflow arrangement includes at least one siphon-like element.

26. The drying roll as claimed in claim 21, wherein each of said plurality of elevations includes two flanks, said plurality of elevations, at least partially, having a cross-sectional form such that an angle formed between said two flanks of a respective said elevation is ≧0° and <140°.

27. The drying roll as claimed in claim 26, wherein each flank includes a slope with a tangent, a point of intersection at which said tangent of said slope applied to both said flanks lying radially between a respective said elevation and a center of the drying roll.

28. The drying roll as claimed in claim 21, wherein said plurality of elevations, at least partially, have an at least essentially rectangular cross-sectional form.

29. The drying roll as claimed in claim 21, wherein said plurality of elevations, at least partially, have an at least essentially trapezoidal cross-sectional form.

30. The drying roll as claimed in claim 21, wherein said plurality of elevations, at least partially, have an at least essentially parabolic cross-sectional form.

31. The drying roll as claimed in claim 21, wherein said plurality of elevations, at least partially, have an at least essentially triangular cross-sectional form.

32. The drying roll as claimed in claim 21, wherein said plurality of elevations are, at least partially, continuous.

33. The drying roll as claimed in claim 21, wherein said plurality of elevations are, at least partially, interrupted.

34. The drying roll as claimed in claim 21, wherein said plurality of elevations include, at least partially, of a plurality of individual sub-sections.

35. The drying roll as claimed in claim 34, wherein said plurality of elevations include, at least partially, a plurality of radial bolt-like sub-sections.

36. The drying roll as claimed in claims 34, wherein said plurality of elevations include, at least partially, a plurality of radial rod-like sub-sections.

37. The drying roll as claimed in claim 21, wherein each of said plurality of elevations have, at least partially, said radial height>2 mm.

38. The drying roll as claimed in claim 37, wherein each of said plurality of elevations have, at least partially, said radial height>3 mm.

39. The drying roll as claimed in claim 38, wherein each of said plurality of elevations have, at least partially, said radial height>5 mm.

40. The drying roll as claimed in claim 39, wherein each of said plurality of elevations have, at least partially, said radial height>10 mm.

41. The drying roll as claimed in claim 21, wherein a radial height of a section of a respective elevation projecting inwards from said condensate layer is one of greater than and the same as half of a width of said respective elevation.

42. The drying roll as claimed in claim 21, wherein said average radial thickness of said condensate layer is around 3 mm.

43. The drying roll as claimed in claim 21, wherein a width of at least one of said plurality of elevations is around 6 mm.

44. The drying roll as claimed in claim 21, wherein when said average radial thickness of said condensate layer is around 3 mm and a width of a particular said elevation is around 6 mm, a radial height (H_{E}) of said particular elevation is ≧6 mm.

45. The drying roll as claimed in claim 21, wherein a radial height of a particular said elevation is one of greater than and the same as half of a width of said particular elevation measured at a radially external foot of said particular elevation, plus a value of around 1 mm.

46. The drying roll as claimed in claim 21, wherein a radial height of a particular said elevation is one of greater than and the same as half of a width of said particular elevation measured at a radially external foot of said particular elevation, plus a value of around 3 mm.

47. The drying roll as claimed in claim 21, wherein when said an average radial thickness of said condensate layer is around 3 mm and a width of a particular said elevation is around 6 mm, a radial height of said particular elevation is at least 6 mm.

48. The drying roll as claimed in claim 21, wherein when said cylinder jacket provided with said plurality of elevations is of a one-piece construction, a radial height of a particular said elevation is <18 mm.

49. The drying roll as claimed in claim 21, wherein said plurality of elevations has a pitch being <100 mm.

50. The drying roll as claimed in claim 49, wherein said plurality of elevations has a pitch being <50 mm.

51. The drying roll as claimed in claim 50, wherein said plurality of elevations has a pitch being <30 mm.

52. The drying roll as claimed in claim 51, wherein said plurality of elevations has a pitch being <15 mm.

53. The drying roll as claimed in claim 21, wherein each of said plurality of elevations and a corresponding said radially external base of an adjoining said groove forms a transition therebetween which is rounded.

54. The drying roll as claimed in claim 53, wherein each of said plurality of ribs and a corresponding said radially external base of a particular said groove forms a transition therebetween which is rounded.

55. The drying roll as claimed in claim 53, wherein said transition has a radius of >1 mm.

56. The drying roll as claimed in claim 55, wherein said transition has a radius of >2 mm.

57. The drying roll as claimed in claim 21, wherein said plurality of ribs and said plurality of grooves are oriented axially, at least partially.

58. The drying roll as claimed in claim 57, wherein all of said plurality of ribs and all of said plurality of grooves are oriented axially

59. The drying roll as claimed in claim 21, wherein said plurality of ribs and said plurality of grooves are oriented, at least partially, in a circumferential direction.

60. The drying roll as claimed in claim 59, wherein all of said plurality of ribs and all of said plurality of grooves are oriented in said circumferential direction.

61. The drying roll as claimed in claims 60, wherein said plurality of grooves are attached to one another, at least partially, via a plurality of channels.

62. The drying roll as claimed in claim 21, wherein said condensate outflow arrangement includes at least one condensate outflow element allocated to each of said plurality of grooves.

63. The drying roll as claimed in claim 62, wherein said at least one condensate outflow element is a siphon.

64. The drying roll as claimed in claim 21, wherein at least one of said plurality of ribs and said plurality of grooves are oriented, at least partially, in a form of one of a spiral, a coil, and a screw thread.
